(19) United States
(12) Patent Application Publication
(10) Pub. No.: US 2009/0176482 A1
(43) Pub. Date: Jul. 9, 2009

(54) METHOD AND SYSTEM FOR DISPLAYING REMOTE CACHE INFORMATION

(76) Inventors: DARYL MARTIN, Paradise (CA); CHRISTOPHER DAVID O'KEEFE, St. John's (CA)

Correspondence Address: BENNETT JONES LLP, 3400 ONE FIRST CANADIAN PLACE, PO BOX 130, TORONTO, ON, M5X 1A4, CA

(21) Appl. No.: 11/970,808

(22) Filed: Jan. 8, 2008

(51) Int. Cl. H04M 3/42

(52) U.S. Cl. 455/414.3

(57) ABSTRACT

A method and system for providing one or more status indicators associated with a request from a device for information from a website. According to an embodiment, information received from the website is stored in a cache, and the status indicators are generated based on the information in the cache. In response to a request from the device one or more of the status indicators are downloaded or otherwise transmitted to the device. According to an embodiment, the request is generated by a user activating an HTML link at the device. The HTML link is associated with an HTML file which stores the status information, and in response to activation, one or more of the status indicators from the HTML file are transmitted to the device.

### FIELD OF THE APPLICATION

The present application relates to communication networks, and more particularly, to a method and system for displaying remote cache information utilizing a modified HTML link.

### BACKGROUND OF THE APPLICATION

Handheld wireless devices with Internet browser capabilities have become commonplace. While using a wireless handheld device, it is helpful for the user to know if a particular webpage has been cached, as this can be the deciding factor for following a HTML link, i.e. a cached webpage will typically download faster. It is a fact that there will be websites that take longer to load on a browser for reasons unrelated to the handheld device or the computer requesting the webpage.

In view of these deficiencies in the art, it will be appreciated that having information about delivery time, download delay, etc., can help a user navigate the Internet more efficiently. Accordingly, there remains a need for improvements in the art.

### SUMMARY

The present application comprises embodiments of a method and system for displaying remote cache information utilizing modified HTML links.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the present application, and in which:

FIG. 1 shows in diagrammatic form an exemplary network environment suitable for operating an embodiment according to the present application;

FIG. 2 shows in schematic form an exemplary mobile wireless communication device which is capable of communicating within the network environment of FIG. 1;

FIG. 3(a) shows in diagrammatic form a screen for operating a mobile communications device in accordance with an embodiment; and

FIG. 3(b) shows in diagrammatic form a screen for operating a mobile communications device in accordance with an embodiment.

Like reference numerals indicate like or corresponding elements in the drawings.

### DETAILED DESCRIPTION OF THE EMBODIMENTS

Embodiments according to the present invention are generally directed to a method and system for providing one or more status indicators associated with a request by a device for information from a website.

According to one broad aspect, there is provided a method for providing status indicators associated with information requested from a website to one or more devices, the method comprises the steps of: sending a request for information from the website from a browser operating on one of the devices; receiving the request at a gateway; processing the request at the gateway and transmitting the request to the website; receiving information from the website and storing the received information in a cache at the gateway; generating one or more status indicators associated with the received information stored in the cache; and making the one or more status indicators available to the one or more devices.

According to another broad aspect, there is provided a system for providing status information associated with a request for information from a website received from a device in a communication network, the system comprises: a browser running on the device and being responsive to an input for generating the request for information; an intermediary server coupled to the communication network and being responsive to the request for information and having a component for transmitting the request to the website; the intermediary server including a cache for storing information received from the website, and a component for generating one or more status indicators associated with the information received from the website, and a component for transmitting one or more of the status indicators to the device.

According to a further broad aspect, there is provided a mechanism for providing status information associated with a request for information from a website, the mechanism comprises: a cache for storing information received from the website; a component for generating one or more status indicators associated with the information received from the website; a file for storing the one or more status indicators; and a component responsive to a status request from the device for transmitting one or more of the status indicators to the device.

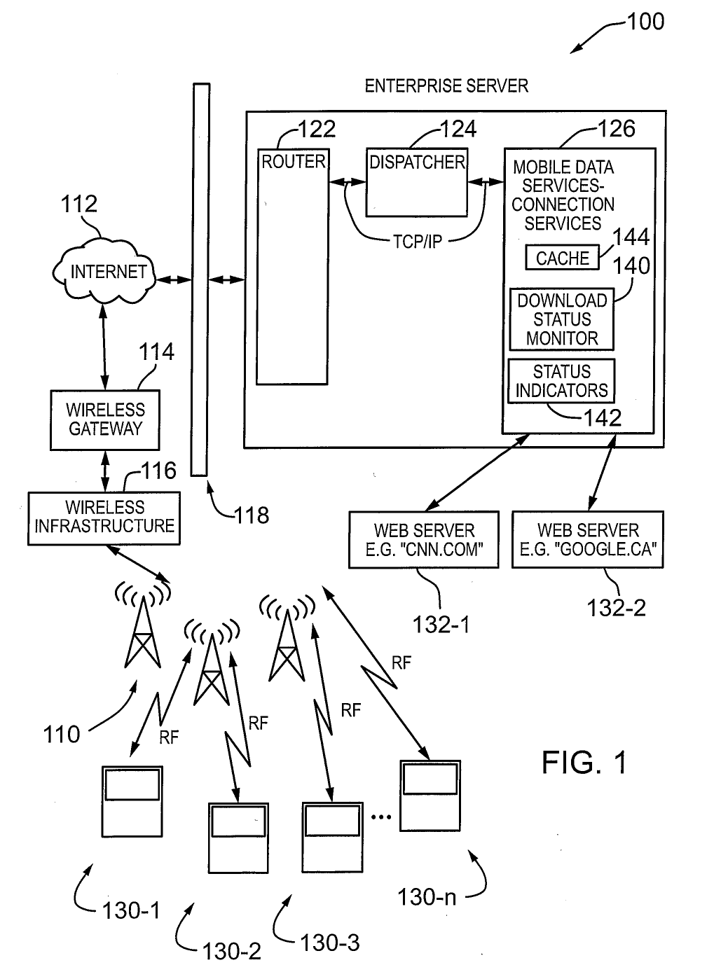

Reference is first made to FIG. 1, which shows in diagrammatic form an exemplary network environment 100 wherein an embodiment as described herein may be practiced. The network environment 100 comprises a wireless network 110, the Internet 112, a wireless gateway 114, a wireless infrastructure 116, and an enterprise server 120. The wireless network 110 serves a plurality of users, each having a mobile communication device (MCD) 130, indicated individually as 130-1, 130-2, . . . 130-n.

The wireless gateway 114 and the wireless infrastructure 116 provide a link between the Internet 112 and the wireless network 110. The wireless infrastructure 116 determines the most likely network for locating a given user and tracks the users as they roam between countries or networks. A message is then delivered to the mobile communication device 130 via wireless transmission, typically at a radio frequency (RF), from a base station in the wireless network 110 to the mobile device 130. The wireless network 110 may comprise any wireless network over which messages may be exchanged with a mobile communication device.

The wireless infrastructure 116 includes a series of connections to wireless network 110. These connections could be Integrated Services Digital Network (ISDN), Frame Relay or T1 connections using the TCP/IP protocol used throughout the Internet. As used herein, the term “wireless network” is intended to include three different types of networks, those being (1) data-centric wireless networks, (2) voice-centric wireless networks and (3) dual-mode networks that can support both voice and data communications over the same physical base stations. Combined dual-mode networks include, but are not limited to, (1) Code Divisional Multiple Access (CDMA) networks, (2) the Group Special Mobile or the Global System for Mobile Communications (GSM) and the General Packet Radio Service (GPRS) networks, and (3) future third-generation (3G) networks like Enhanced Data-rates for Global Evolution (EDGE) and Universal Mobile Telecommunications Systems (UMTS). Some older examples of data-centric networks include the Mobitex.™. Radio Network and the DataTAC.™. Radio Network. Examples of older voice-centric data networks include Personal Communication Systems (PCS) networks like GSM, and TDMA systems.

The enterprise server 120 may be implemented, for example, on a network computer within a firewall 118 for a corporation, a computer within an ISP system or the like. The enterprise server 120 provides an interface for email exchange over the Internet 112 and web access on the Internet 112 for mobile communication devices 130 equipped with a browser or having browser capability as will be described in more detail below.

The enterprise server 120, for example, implemented as a BlackBerry® Enterprise Server or BES, comprises a software module running on a server that acts as the centralized link between the mobile wireless communication devices 130, the wireless networks 110 and the enterprise applications. The server 120 integrates with enterprise messaging (e.g. Microsoft Exchange email system) and collaboration systems to provide the users of the mobile communication devices 130 with access to email, enterprise instant messaging and personal information management tools. All data between applications and the mobile communication devices 130 flows centrally through the enterprise server 120. As shown in FIG. 1, the enterprise server 120 comprises a router 122, a dispatcher 124 and a Mobile Data Services-Connection Services (MDS-CS) module or system 126.

The router 122 is designed to connect to the wireless network 110 to route data to and from the mobile wireless communication devices 130. The dispatcher 124 is designed to compress and encrypt the data communications for the mobile communication devices 130. The dispatcher 124 routes or moves the data through the router 122 to and from the wireless network 110. The Mobile Data Services module 126, for example, the BlackBerry® MDS™ Connection Service, functions as a gateway and is designed to manage interactions and requests between mobile wireless communication devices 130 (for example, BlackBerry® handheld devices) and enterprise applications. The Mobile Data Services system 126 enables always-on/push-based access to enterprise applications and information using the mobile communication device 130, browser and software development tools. The MDS 126 provides connectivity (i.e. HTTP/HTTPS) to the Internet 112. In addition, the MDS 126 provides an extensible and secure interface for extending corporate applications and the corporate Intranet based on existing web standards.

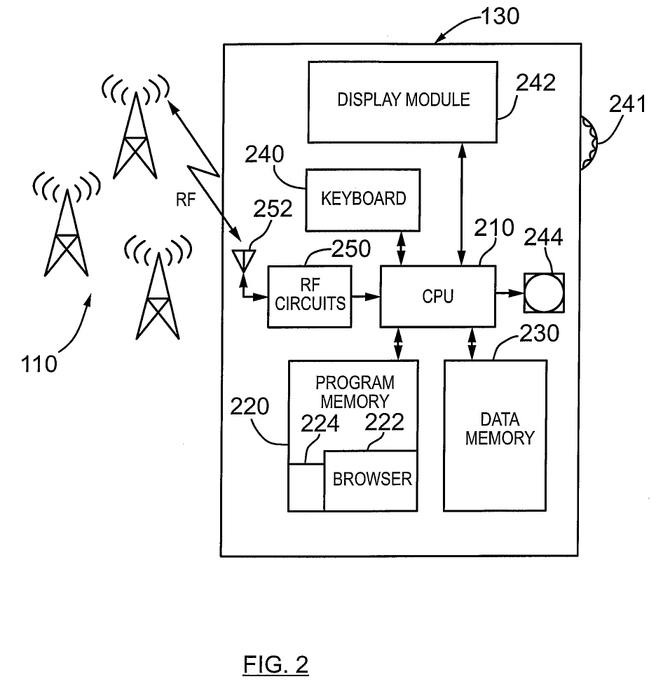

Reference is next made to FIG. 2, which shows in more detail an exemplary implementation of the mobile communication device 130. The mobile communication device 130 comprises a central processing unit or CPU 210. The CPU 210 operates under the control of a program (i.e. firmware or software) stored in program memory 220. The CPU 210 is also provided with data memory 230. The CPU 210 is operatively coupled to a keyboard and track wheel 240 or a trackball (not shown), a display module 242 and an audio transducer or speaker 244. In addition to the program executable code providing for performing the functions associated with the operation of the mobile communication device 130, the program memory 220 includes a browser program 222. The browser program 222 allows a user to access web pages on the Internet 112 using the mobile communication device 130, i.e. utilizing a graphical user interface comprising, for example, the keyboard 240 and the display module 242 and/or a track wheel 241.

As shown, the mobile communication device 130 includes a RF demodulation/modulation and decoding/coding circuits 250, and a suitable RF antenna 252. The RF demodulator/modulator and decoder/coder circuits 250 and the RF antenna 252 are operatively coupled to the CPU 210 and provide an interface for wireless communication with the wireless network 110. The particular implementation details of the RF circuits will be within the understanding of those skilled in the art, and is therefore not described in further detail.

To browse the Internet, the user invokes the browser program 222 in the mobile communication device 130 and using the graphical user interface (i.e. the display 242, the keyboard 240 and/or a thumb-operated track wheel 241) enters the URL or a bookmark for a website of interest, for example, http://www.google.ca. The browser 222 converts the user entry into a HTTP request and sends the request to the enterprise server 120. According to an embodiment, the device 130 includes a program module 224 which takes the HTTP request and converts and compresses it into a data format which is then sent to the enterprise server 120. The enterprise server 120, i.e. the MDS-CS 126, processes the HTTP request received from the handheld device 130 and transmits the HTTP request to the web server, for example, web server 132 for “google.ca”. In response to the request, the web server 132-1 returns the requested or corresponding webpage, which is relayed by the MDS-CS 126 to the mobile communications device 130. According to an embodiment, the MDS-CS 126 converts and compresses the data or information from the web site into a data format that is more efficient for wireless transmission.

The originating client, for example, a web browser, is typically referred to as the “user agent”. The destination server stores resources, such as, HTML files and images, and is typically referred to as the “origin server”. In between the user agent and the origin server there may be several intermediaries, for example, proxies and gateways. In the context of the present application, the mobile handheld devices 130 comprise user agents, the enterprise server or module 120 comprises an intermediary server or a MDS-CS module 126, and the web servers 132 comprise origin servers. According to an embodiment, the intermediary server is located or configured behind a firewall.

According to an embodiment, the enterprise server 120 includes a webpage download status monitor indicated generally by reference 140. The download status monitor 140 provides a mechanism to determine the download status of the requested webpage and provide status information to the user of the mobile communication device 130 as will be described in more detail below. The download status monitor 140 may be implemented as a software module or object in the MDS-CS 126, which may also be implemented as a software module according to an embodiment.

According to one embodiment, the webpage download status monitor 140 is implemented with an HTML/HTTP based mechanism. HTTP (i.e. Hypertext Transfer Protocol) is a method for transferring information on the World Wide Web (i.e. “www”), and comprises a request/response protocol between clients and servers. The originating client, for example, a web browser, is typically referred to as the “user agent”. The destination server stores resources, such as, HTML files and images, and is typically referred to as the “origin server”. In between the user agent and the origin server there may be several intermediaries, for example, proxies and gateways. In the context of the present application, the mobile handheld devices 130 comprise user agents, the MDS-CS system or module 126 comprises a gateway, and the web servers 132 comprise origin servers.

According to an embodiment, the mobile handheld device 130, i.e. the HTTP client, initiates a request by transmitting the request to the MDS-CS 126. The MDS-CS 126, in turn, establishes a Transmission Control Protocol (TCP) connection to a port on a remote host and the HTTP server (i.e. web server 130) listening on that port waits for the request message. Upon receiving the request, the web server 130 sends back a status line, such as “HTTP/1.1 404 OK”, and a message having a body for the requested file or information or webpage. The MDS-CS 126 converts the message received from the web server 130 into a format or protocol suitable for transmission (e.g. wireless transmission with data compression) to the mobile communication device 130. The formatted message is received by the mobile handheld device 130 and converted by the device and/or browser program 222 (i.e. executed from the program memory 220) into a display format for the display module 242.

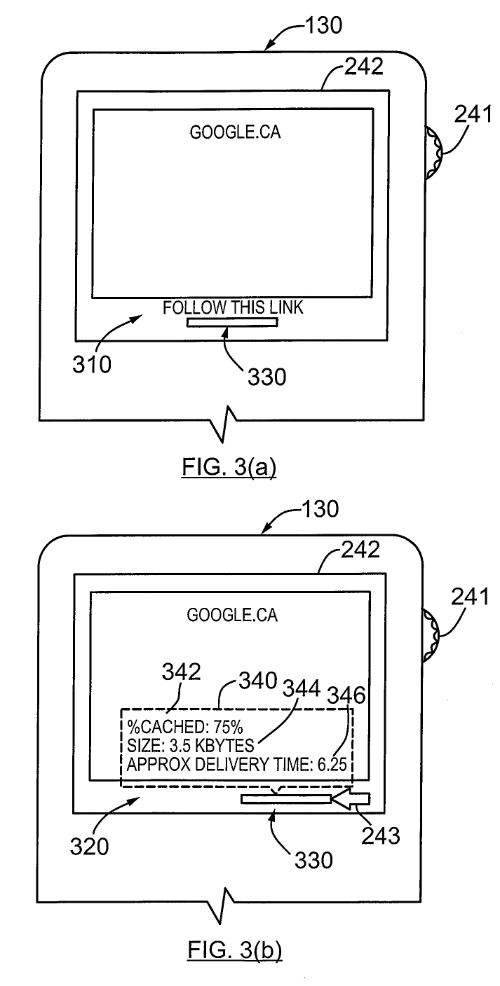

According to one embodiment, the webpage download status monitor 140 comprises an HTML-based mechanism. According to one embodiment, the download status monitor 140 monitors the downloading or caching (i.e. in cache 144) of the requested webpage from the web server 132, and collects and generates status indicators and/or download statistics associated with the webpage download or cached webpage. According to one embodiment, the status indicators comprise a file size indicator, a cache percentage (%) indicator, and an approximate download or delivery time indication. The status indicators are displayed or accessed via the mobile handheld device 130, for example, by way of a graphical user interface or GUI as indicated by reference 310 in FIG. 3(a). According to one embodiment, the status indicators are stored in an HTML file 142 (FIG. 2) or other type of hypertext based or web resource, for example, in the MDS-CS 126, and an HTML link (i.e. hyperlink) having the form, for example, as shown in FIG. 3(a) and indicated by reference 330 is provided. The HTML link 330 is activated, for example, as shown in FIG. 3(a) by moving the cursor 243 over the hypertext using the track wheel 241 or other navigation keys on the keyboard 240. In response to the activation (i.e. “mousing”) of the HTML link 330, the browser program 222 creates a link with the HTML file 142 on the MDS-CS 126, and the corresponding status indicators are downloaded or transferred to the browser 222.

According to one embodiment, the status indicators are presented in a popup window, box or balloon, for example, having the form as shown in FIG. 3(b) and indicated generally by reference 340. As shown in FIG. 3(b), the popup window 340 comprises a “% cached” display field or line 342, a file “Size” display field or line 344, and an “Approx Delivery Time” display field or line 346. According to one embodiment, the download status monitor 140 generates an HTML data message having the following form:
<a href=http://rim.com; <http://www.rim.com>% Cached=75%; Size=3.5 KB;
Delivery Time=6.2 s>RIM</a>
   According to this aspect, the MDS-CS 126 functions as a proxy or gateway for the mobile handheld device 130, and the % Cached field 342 displays the percentage or portion of the webpage or file that is cached at the MDS-CS 126, i.e. remains to be downloaded to the handheld device 130. The Size field 344 displays the size of the webpage or file that is being downloaded. The Approx Delivery Time field displays the estimated time for downloading the webpage or file to the handheld device 130. The software functions or modules for determining cached file percentage, file size and estimated delivery time may be implemented in the download status monitor 140 and/or the MDS-CS 126, and the particular implementation details will be apparent to one skilled in the art.

According to another embodiment, the status information or indicators may include a % Cached on Server field, a % Cached on Device field, an Age of the Cached Information field, and/or an Approximation of Data Transmitted to the Device field. In addition, the status information may include general information on the webpage or download.

According to another embodiment, the HTML link 330 may be implemented utilizing one or more colours to differentiate the link 330 and/or different states of the link in a graphical user interface. For example, the colour of the HTML link 330 may be displayed in a defined colour to indicate that the requested webpage has been cached, and by moving the cursor over the link 330, the associated status data is displayed.

While the embodiments of the system and methods have been described in the context of wireless or mobile communication devices, it will be appreciated that the systems and methods have wider applicability to other types of devices or computers that receive web pages.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A method for providing status indicators associated with information requested from a website to one or more devices, said method comprising the steps of:
sending a request for information from the website from a browser operating on one of the devices;
receiving said request at a gateway;
processing said request at said gateway and transmitting said request to the website;
receiving information from the website and storing said received information in a cache at said gateway;
generating one or more status indicators associated with said received information stored in said cache; and
making said one or more status indicators available to the one or more devices.

2. The method as claimed in claim 1, wherein said step of making said one or more status indicators available to said device comprises transmitting said one or more status indicators to said device in response to a status request, and said status request being generated at one of the devices.

3. The method as claimed in claim 2, wherein said status request comprises an HTML link, and said HTML link being responsive to a user input on the device.

4. The method as claimed in claim 3, wherein said status indicators comprise one or more of a file size estimate, a cache percentage, a delivery time estimate and general information associated with the website.

5. The method as claimed in claim 1, wherein the device comprises a mobile communication device.

6. A system for providing status information associated with a request for information from a website received from a device in a communication network, said system comprising:
a browser running on the device and being responsive to an input for generating the request for information;
an intermediary server coupled to the communication network and being responsive to the request for information and having a component for transmitting the request to the website;
said intermediary server including a cache for storing information received from the website, and a component for generating one or more status indicators associated with the information received from the website, and a component for transmitting one or more of said status indicators to the device.

7. The system as claimed in claim 6, wherein said component for transmitting one or more of said status indicators is responsive to a status request from the device.

8. The system as claimed in claim 7, wherein said intermediary server includes an HTML file, and said one or more status indicators being stored in said HTML file.

9. The system as claimed in claim 8, wherein said status request comprises an HTML link associated with said HTML file, and said HTML link being responsive to a user input at the device.

10. The system as claimed in claim 9, wherein said one or more status indicators are displayed on the device.

11. The system as claimed in claim 10, wherein said status indicators comprise one or more of a file size estimate, a cache percentage and a delivery time estimate.

12. The system as claimed in claim 6, wherein said intermediary server is associated with an enterprise server.

13. The system as claimed in claim 6, wherein said intermediary server is located behind a firewall.

14. A mechanism for providing status information associated with a request for information from a website, said mechanism comprising:
a cache for storing information received from the website;
a component for generating one or more status indicators associated with said information received from the website;
a file for storing said one or more status indicators; and
a component responsive to a status request from the device for transmitting one or more of said status indicators to a device.

15. The mechanism as claimed in claim 14, wherein said status request comprises an HTML link, and said HTML link being associated with said file.

16. The mechanism as claimed in claim 15, wherein said file comprises an HTML file, and said HTML file being linked to said HTML link on said device.

17. The mechanism as claimed in claim 16, wherein the device includes a graphical user interface for activating said HTML link and displaying said one or more status indicators transmitted to said device.

18. The mechanism as claimed in claim 17, wherein said status indicators comprise one or more of a file size estimate, a cache percentage and a delivery time estimate.

19. The mechanism as claimed in claim 18, wherein said device comprises a mobile communication device, said mobile communication device being operatively coupled to a wireless communication network.

20. The mechanism as claimed in claim 17, wherein said device comprises a computer operatively coupled to a communication network.
